(19) United States
(12) Patent Application Publication
(10) Pub. No.: US 2004/0224130 A1
(43) Pub. Date: Nov. 11, 2004

(54) Customizable universal elastomeric mat

(76) Inventors: Thomas A. Melucci, Lincoln, RI (US); Craig C. Melucci, Lincoln, RI (US)

Correspondence Address: BARLOW, JOSEPHS & HOLMES, LTD., 101 DYER STREET, 5TH FLOOR, PROVIDENCE, RI, 02903, US

(21) Appl. No.: 10/821,683

(22) Filed: Apr. 9, 2004

Related U.S. Application Data
(60) Provisional application No. 60/461,486, filed on Apr. 9, 2003.

(51) Int. Cl. B32B 3/02

(52) U.S. Cl. 428/156; 428/174

(57) ABSTRACT

A universal and customizable elastomeric floor mat and a method of manufacturing the same. In general, the present invention provides a new and improved elastomeric mat that provides for modularized customization by including a blank receiving area in the base mat product. A separate insert component bearing the desired logo or customization is molded separately. The insert is then permanently installed into the receiving area to provide an integrated mat that has a high quality OEM appearance, while reducing the amount of tooling and inventory that has to be maintained for similar products in the prior art.

### CROSS-REFERENCE TO RELATED APPLICATIONS

This application is related to and claims priority from earlier filed provisional patent application No. 60/461,486 filed Apr. 9, 2003.

### BACKGROUND OF THE INVENTION

The present invention relates generally to a universal and customizable elastomeric sheet product. More specifically, the present invention relates to a universal elastomeric mat product such as a vehicle floor mat with a recess provided therein for receiving a customized insert that gives the mat a high quality, OEM appearance while allowing the mat to contain specific indicia relating to the vehicle model, manufacturer or reseller.

Accessory floor mats are widely used to protect floors from foot traffic, to shield against potential stains from spills and to reduce the wear and tear on the carpeted floors of vehicles. The mats used in such applications are typically made of an elastomeric material thereby providing the ability to contain spills or other undesirable contaminants while remaining sufficiently flexible to generally conform to a variety of applications such as the contours of vehicle floors.

In general this type mat is formed using open pour molding, injection molding or compression molding. In open pour molding, thermoplastic materials or curable elastomeric polymers are dispensed in liquid form into an open cavity mold and cured, generally using heat or exposure to intense light. Similarly, in injection molding, the base material is injected into a closed cavity mold in molten form and allowed to cure, generally through a cooling process, before opening the mold cavity and removing the product. Finally, in compression molding a sheet or partially cured material is placed between two halves of a mold die wherein the mold is compressed around the sheet of material and the material is cured in the compressed form. Regardless of the manner used to form the mat, these mats are generally dimensioned for an exact fit to a particular application such as a particularly shaped vehicle floor well. Some of these mats further incorporate raised borders to trap dirt, water and snow. Some of these mats have also included a studded bottom surface where they contact the floor or carpet to maintain their position and prevent slipping.

As can be appreciated, there is a potentially infinite number of applications available for implementation of a mat fabricated as described above. In the vehicle industry alone, there are a large number of different types of vehicles on the market, resulting in a large variety of sizes and shapes of mats required to fit all of the vehicle models. Further, the vehicle manufacturer often wants a mat that has an OEM or custom fit appearance thereby requiring a mat that is custom engineered to fit the exact dimensions of the vehicle. This is coupled with the vehicle manufacturer or reseller's desire to have their name or logo prominently displayed in the surface of the mat. To achieve all of these requirements, a custom mold must be cut for each and every mat configuration required. Even within a specific family of similarly shaped mats, should each particular reseller of the mat desire the mat to carry the reseller's name, a different mold would be required for each reseller. This also results in not only the need to tool and store a great number of molds but also a requirement for maintaining a certain level of inventory for each type of mat.

Prior art attempts have been made whereby the molds have been manufactured to include a cut out area that allows for the placement of a molding insert for customized insert into the base mold before a molding run. This method however introduces an additional layer of complexity to the tooling requirements and tends to be quite costly. The machining cost for the molds increases and the need for high precision tooling and coordination of various components greatly increases the set up cost for using such an arrangement.

Although these mats have served the purpose for which they are designed, they have not proved entirely satisfactory mainly because as described above separate mats must be manufactured to fit and properly cover automobile floors of various sizes and configurations. Similarly, if a manufacturer were also to supply other product lines such as mud flaps, welcome mats or other consumer products the tooling needs would increase exponentially, thereby requiring a large number of custom molds, the storage space required for each of the molds and warehouse space to store an inventory for each type of mat. As can be appreciated all of these factors combine to increase the overall cost of manufacturing this type of elastomeric mat.

There is therefore a need for a unique system and method for manufacturing an elastomeric mat that allows for the desired customization of the mat without the requirement for retooling an entire mold for each mat manufactured. Further, there is a need for the ability to create a customized mat that includes the desired logo or indicia of the reseller or purchaser while preserving the appearance that the mat has the same level of quality and integration as an OEM part or component.

### BRIEF SUMMARY OF THE INVENTION

In this regard, the present invention provides a universal and customizable elastomeric floor mat and a method of manufacturing the same. As such, the general purpose of the present invention, which will be described subsequently in greater detail, is to provide a new and improved elastomeric mat that provides for modularized customization while reducing the amount of tooling and inventory that has to be maintained for similar products in the prior art.

In accordance with the present invention, a universal elastomeric mat is provided that facilitates the inclusion of customized indicia such as monograms, logos, vehicle model, vehicle make or reseller specific information. The present invention provides for a molded elastomeric mat to be formed with an opening provided therein to receive and support a secondary insert. The opening is preferably provided as a rectangular area that extends only partially through the full thickness of the mat, although a full depth opening may also be provided. Inserts are formed that closely match dimensions of the opening in the mat (preferably within 0.001″). Both the mats and inserts may be formed by utilizing either a traditional open pour molding operation, injection molding or compression molding.

To facilitate the integrated appearance and OEM quality feel of the mats formed using the disclosure of the present invention, the inserts include a pattern printed thereon that matches the surrounding pattern of the mat into which the insert will be placed. Further, the inserts include printed or molded indicia thereon. The indicia may include a logo that relates to a specific vehicle make or model. Alternately, the indicia may be related to the car dealer that is offering the vehicle for sale. Similarly, for non-vehicle applications, a welcome mat may include the last name of the homeowner or business purchasing the mat or may include a club or affiliation logo. The examples provided are intended only to be illustrative of the possible applications or forms which the elastomeric mats may take and the actual contents of the printed or molded indicia are not intended to be a limitation on the scope of the invention, as the indicia could take any imaginable form.

The inserts are molded separately from the mate itself. When the inserts are placed into the opening provided in the mat, they are engineered to fit snugly. An adhesive material may further be incorporated to retain the insert permanently in place in the mat. When the insert is installed in place, the pattern of the insert closely matches the pattern of the surrounding mat to make the two pieces appear integrally formed. This is in accordance with the goal of the present invention to provide a vehicle mat that has a seamless, custom appearance that has an OEM level of quality.

The molded mats are preferably standardized to some extent with respect to size and shape. For example, the mats may be provided in a large, medium and small size range to fit a large variety of vehicles without requiring a custom shaped mat for every vehicle model. Alternately the mats may be tailored to a family of similarvehicles wherein the floor pan areas are similarly shaped. Additionally, one or two standard welcome mats or cargo protector mats may be made. Each of the mats would however include a standardized recess area fro receipt of an insert for customization.

It is therefore an object of the present invention to provide a standardized elastomeric floor mat that can be easily customized as desired by the purchaser without the requirement for complete retooling of the molding equipment. It is another object of the present invention to provide an elastomeric mat that can include indicia as desired by the purchaser of the mat while maintaining an integrated and quality appearance. It is yet a further object of the present invention to provide a method of manufacturing an elastomeric mat that further allows customization without the need for tooling and storage of a new mold for each and every customized application.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a customizable elastomeric mat and two custom inserts in accordance with the preferred embodiment of the present invention;

FIG. 2 is a front perspective view of the cutout for receiving the custom insert;

FIG. 3 is front perspective view showing the custom insert installed into the cutout;

FIG. 4 is close up view showing the custom insert installed into the cutout;

FIG. 5a is an exploded cross-sectional view taken along line 5-5 in FIG. 4; and

FIG. 5b is a cross-sectional assembly view taken along line 5-5 in FIG. 4.

### DETAILED DESCRIPTION OF THE INVENTION

Now referring to the drawings, the customizable elastomeric mat of the present invention is shown and generally illustrated in the figures at 10. In general the mat 10 has two components, a base mat 12 and a customizable insert 14. The base mat 12 is formed with a receiving area 16 therein and as will be more fully discussed below, the customized insert 14 is affixed into the receiving area 16 to provide the mat 10 with a quality integrated appearance. It is an important feature of the present invention that the mat 10 itself has an appearance as if it were customized in the manufacturing process as an OEM specification product.

In FIG. 1, the base mat 12 is shown as being molded in the shape of a typical vehicle floor mat. While a vehicle floor mat is shown in the present application for purposes of the preferred embodiment, it can be appreciated that the elastomeric mat of the present invention could be formed as any type of mat and still fall within the scope of the present invention. For example, the mat 12 may be formed as a welcome mat, a vehicle floor mat, a cargo mat for use in the cargo bay of a van, a trunk mat, a mat for use beneath pet food and water bowls to contain spills or a vehicle mud flap. It is important to note that the preceding list was provided for purposes of illustration and not meant to be limiting on the potential scope of the invention. The customizable feature of the invention is the novel concept toward which the present disclosure is directed.

The base mat 12, shown as a vehicle floor mat in the preferred embodiment is formed as a substantially flat elastomeric mat having a pattern of raised structures 18 thereon. The raised structures 18 are placed to create an aesthetic pattern that may be artistic or related in some way to the vehicle brand or model for which the mat 10 is manufactured. In addition to serving an aesthetic purpose, the raised rib structures 18 function to trap and retain dirt and fluids on the pat to prevent them from spilling onto or staining the carpet that the mat 10 is intended to protect. As can be seen, a recessed receiving area 16 is also provided on the base mat 12. The receiving area 16 is configured to receive and retain a customized insert 14 as will be further described below. The receiving area 16 is essentially a flat recessed area formed in the base mat 12 that is sized and shaped to closely match the size and shape of the intended customized insert 14. In this figure, the receiving area 16 is shown to include a bottom wall 20. While a bottom wall 20 is shown, it is not required. Clearly, the receiving area 16 can be formed to extend entirely through the thickness of the base mat 12 and still fall within the scope of the present invention. The receiving area 16 preferably has a depth that extends deeper than the top surface 22 of the field area in the pattern of the base mat 12. This depth allows the receiving area 16 to have a side wall 24 that fully engages the sides of the insert 14 when the insert 14 is installed and assists in concealing the parting lines 26 between the insert 14 and the surrounding base mat 12.

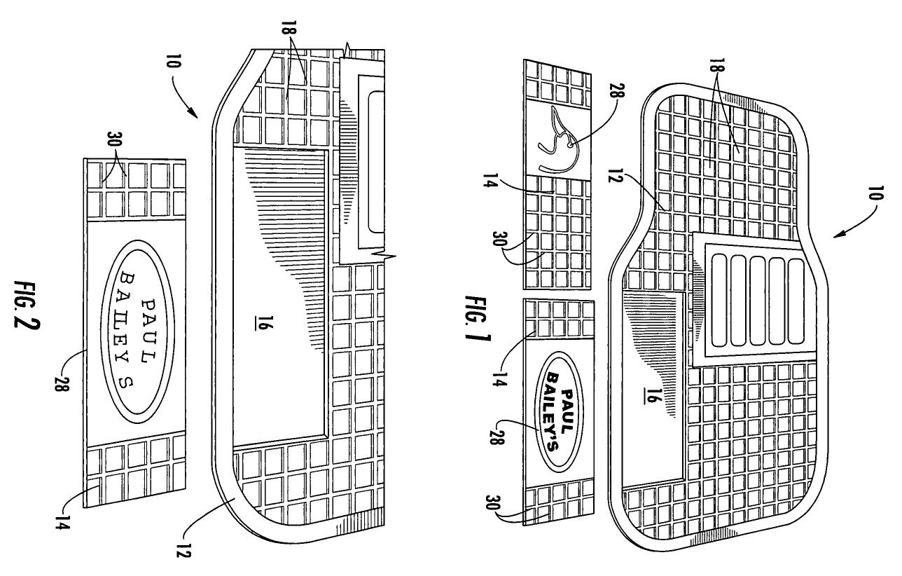

Turning now to FIG. 2, a magnified view of the receiving area 16 and the customized insert 14 of the present invention are shown. It can be seen that the customized insert 14 is shaped to correspond to the shape of the receiving area 16 provided on the base mat 12. While for the purpose of illustration the receiving area 16 is shown as rectangular, clearly, any other imaginable shape such as curved, circular, triangular, trapezoidal, etc would also fall within the scope of the disclosure. Further, the portion of the customized insert 14 that is not covered by the logo or indicia 28 includes raised structures 30 that correspond in appearance to the raised structures 18 on the base mat 12. Specifically, the insert 14 includes a pattern of raised structures or indicia 28 that matches the pattern of raised structures or indicia 18 on the base mat 12. In this manner the insert 14 is configured to integrate with the body of the base mat 12 to conceal the parting line 26 between the insert 14 and the base mat 12. This is an important component of the present invention that facilitates an integrated appearance of the base mat 12 and insert 14 when fully assembled, creating the illusion that the base mat 12 and insert 14 were at the same time as integral components. In particular, close tolerances are used when creating the receiving area 16 on the base mat 12 and the insert 14. Preferably, the dimensions of the interior of the receiving area 16 and the overall outer dimensions of the insert 14 are within 0.001″ of one another to provide a closely tailored fit that has a seamless appearance.

In the preferred embodiment of the present invention both the base mat 12 and the insert 14 are formed from an elastomeric polymer matrix. The elastomer selected may be rubber, polyvinyl chloride (PVC), thermoplastic elastomer (TPE), thermoplastic olefin (TPO) or any other suitable elastomeric material. Further, in certain applications, such as when the mat 10 is fabricated for use as a mud flap, the elastomer will be reinforced using a material such as a glass fiber reinforcing mat. In this manner, the fiber reinforcing is provided to increase the overall strength and durability of the mat 10 in applications where it will be subjected to high stress and wear. As was stated above, the base mat 12 and insert 14 are formed using any conventional molding process known in the art. Preferably, the base mat 12 and insert 14 are formed using open pour molding, injection molding or compression molding. In any of these methods, a mold cavity is formed to include the general outline shape of the base mat 12 with the desired rib or design pattern 18 thereon. Further, the mold cavity is formed to create the necessary receiving area 16 within the body of the base mat 12. Another mold cavity is provided to create the desired customized insert 14. A molten elastomer matrix is prepared and placed into the mold cavities. The elastomer is then cured by applying heat or light in some cases or simply allowing the polymer to cure in ambient conditions. The base mat 12 and insert 14 are then removed form their respective molds and assembled to create the finished, customized mat 10 of the present invention.

The final assembly step, wherein the insert 14 is installed into the receiving area 16, may be accomplished at the point of original manufacture, at the point of sale or at any point of distribution in between. It is anticipated that an adhesive 32 will be employed when installing the insert 14 into the base mat 12 to create a permanent bond between the base mat 12 and the insert 14.

By producing the mats 10 in accordance with the present invention, only one full sized mold cavity must to be tooled for manufacturing a number of mats that would be employed across several similar shaped vehicles. In contrast to the prior art, if a mat were being made for both a Volkswagen Passat and an Audi A4, two full sized sets of mold cavities would have to be made to allow the mats to bear either the Audi logo or the Volkswagen logo. Using the present invention, since the basic shape of the floor pans in both the Audi and Volkswagen are nearly identical, one set of molds can be made to form the base mats 12 and two single smaller molds can be made to produce the logo inserts 14 that would be received into the receiving area 16 bearing either the Audi or Volkswagen logo.

In another example, the overall reduction in required mold inventory can be highlighted by the fact that the same shape mat 10 can be made to fit into a variety of cars while allowing customization not only with respect to identifiers for the brand or make of the car but also to provide a mat 10 that in all respects has the tailored fit and appearance of an OEM part while allowing the vehicle reseller or rental agency to place their indicia or logo in the receiving area 16 on the mat 10. Similarly, a standard sized and shaped welcome mat 10 could be provided to a retailer such as L.L. Bean or to a club organization such as Ducks Unlimited with their particular logo molded onto the insert 16 without retooling the entire mold for the welcome mat 10. All that needs to be made is a much smaller and less expensive mold for the formation of the customized insert 16.

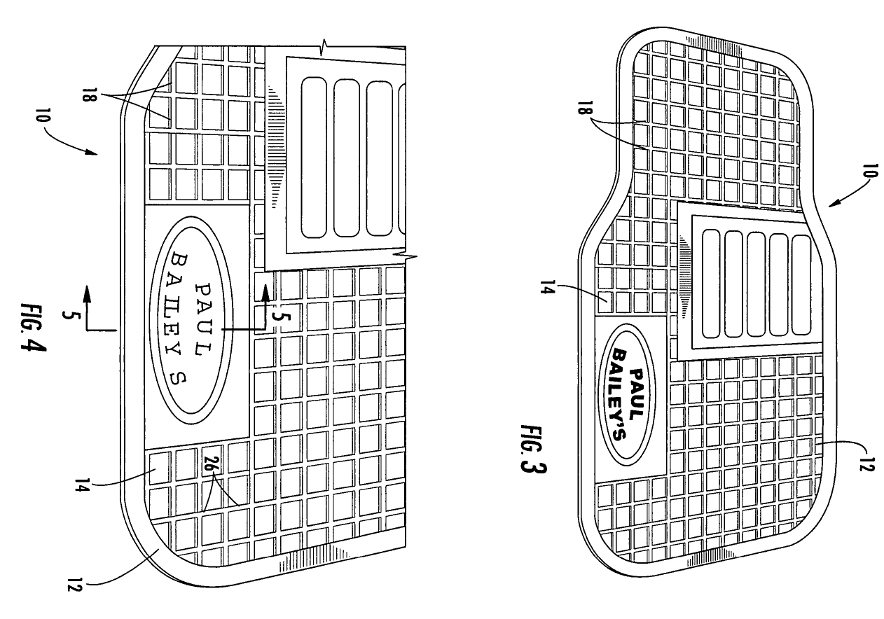

Turning now to FIGS. 3 and 4, the mat 10 of the present invention is shown with the insert 14 placed into the receiving area 16. As can be seen the insert 14 appears as if it were molded integrally with the base mat 12. This is achieved as a result of the close tolerances used in molding the base mat 12 and the insert 14 as well as the use of the matching patterns 18, 30 both on the base mat 12 as well as on the insert 14. Further, the walls 24 of the receiving area 16 are designed to align with the natural breaks of the established pattern thereby further assisting in concealing the parting lines 26.

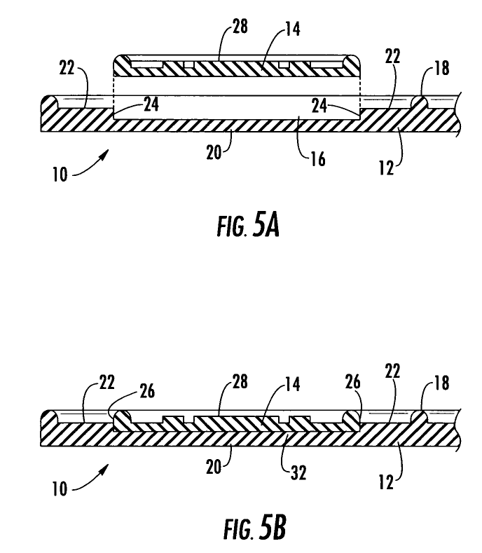

Turning now to FIGS. 5a and 5b, a cross sectional view taken through the base mat 12 and insert 14 at the receiving area 16 is shown. The two figures taken in combination illustrate the manner in which the mat 10 is assembled in accordance with the disclosure of the present invention. The mat 10 is shown to include the receiving area 16 which extends partially into the thickness of the mat 12. Preferably, the receiving area 16 extends deeper than the pattern details 18 on the surface of the base mat 12 but not entirely through the base mat 12. The receiving area 16 could however, extend entirely through the base mat 12 and still fall within the scope of the present invention. The insert 14 is placed into the receiving area 16 and is preferably adhered in place using a layer of adhesive material 32. It can be seen, particularly in FIG. 5b, that when the insert 14 is received into the receiving area 16, the pattern 30 on the insert 14 matches the pattern 18 on the base mat 12. Further, since the parting line 26 is placed along a natural break in the pattern, the parting lines 26 are partially concealed by the pattern change.

It can therefore be seen that the present invention provides a novel elastomeric mat 10 that can be customized with the logo or indicia desired by the end user without the need for retooling the entire mold cavity for each custom application. Further, the disclosure of the present invention has broad application for any elastomeric mat 10 product allowing elastomeric mats for a variety of applications that can be customized without having to create an entirely new mold for each customization. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A customizable elastomeric mat comprising:
a base mat having a top surface with a first pattern on a first portion thereof, said top surface having a recessed area on a second portion thereof, said recessed area having side walls extending downwardly from said top surface; and
an insert member, said insert member having a shape and size closely matched to said side walls of said recessed area, said insert member configured to be received into said recessed area, said insert member having a top surface with indicia on a first portion thereof and a second pattern on a second portion thereof,
wherein said second pattern matches and aligns with said first pattern when said insert member is received in said recessed area.

2. The customizable elastomeric mat of claim 1, further comprising:
an adhesive material disposed between said insert member and said base mat, said adhesive material permanently retaining said insert member in said recessed area.

3. The customizable elastomeric mat of claim 1, wherein said mat is selected from the group consisting of: a welcome mat, a vehicle floor mat, a cargo mat for use in the cargo bay of a van, a trunk mat, a mat for use beneath pet food and water bowls to contain spills and a vehicle mud flap.

4. The customizable elastomeric mat of claim 1, wherein said base mat and said insert member are made of a material selected from the group consisting of: polyvinyl chloride, rubber, thermoplastic elastomer, thermoplastic olefin and mixtures thereof.

5. The customizable elastomeric mat of claim 4, further comprising fiber reinforcing disposed within said elastomer.

6. The customizable elastomeric mat of claim 1, said first pattern further comprising raised rib structures on the top surface of said base mat and said second pattern further comprises raised rib structures on the top surface of said insert member.

7. The customizable elastomeric mat of claim 1, said indicia further comprising raised molded indicia on said top surface of said insert.

8. The customizable elastomeric mat of claim 1 wherein the size and shape of said side walls and the size and shape of said insert member are within 0.001″ of each other.

9. A customizable elastomeric mat comprising:
a base mat having a top surface with a first pattern on a first portion thereof, said top surface having a recessed area on a second portion thereof, said recessed area having side walls extending downwardly from said top surface and a bottom wall substantially parallel to said top surface;
an insert member, said insert member having a shape and size closely matched to said side walls of said recessed area, said insert member configured to be received into said recessed area, said insert member having a bottom surface and a top surface with indicia on a first portion of said top surface and a second pattern on a second portion of said top surface; and
an adhesive material disposed between said bottom wall of said recessed area and said bottom surface of said insert member to permanently retain said insert member in said recessed area,
wherein said second pattern matches and aligns with said first pattern when said insert member is received in said recessed area.

10. The customizable elastomeric mat of claim 9, wherein said mat is selected from the group consisting of: a welcome mat, a vehicle floor mat, a cargo mat for use in the cargo bay of a van, a trunk mat, a mat for use beneath pet food and water bowls to contain spills and a vehicle mud flap.

11. The customizable elastomeric mat of claim 9, wherein said base mat and said insert member are made of a material selected from the group consisting of: polyvinyl chloride, rubber, thermoplastic elastomer, thermoplastic olefin and mixtures thereof.

12. The customizable elastomeric mat of claim 11, further comprising fiber reinforcing disposed within said elastomer.

13. The customizable elastomeric mat of claim 9, said first pattern further comprising raised rib structures on the top surface of said base mat and said second pattern further comprises raised rib structures on the top surface of said insert member.

14. The customizable elastomeric mat of claim 9, said indicia further comprising raised molded indicia on said top surface of said insert.

15. The customizable elastomeric mat of claim 9, wherein the size and shape of said side walls and the size and shape of said insert member are within 0.001″ of each other.

16. A method of manufacturing a customizable elastomeric mat comprising:
providing a first mold cavity;
molding an elastomeric base mat in said first mold cavity, said base mat having a top surface with a first pattern on a first portion thereof, said top surface having a recessed area on a second portion thereof, said recessed area having side walls extending downwardly from said top surface and a bottom wall substantially parallel to said top surface;
providing a second mold cavity;
molding an elastomeric insert member in said second mold cavity, said insert member having a shape and size closely matched to said side walls of said recessed area, said insert member configured to be received into said recessed area, said insert member having a bottom surface and a top surface with indicia on a first portion of said top surface and a second pattern on a second portion of said top surface;
removing said base mat and said insert from said first and second mold cavities; and
applying said insert member into said recessed area on said base mat, wherein said second pattern matches and aligns with said first pattern when said insert member is received in said recessed area.

17. The method of manufacturing a customizable elastomeric mat of claim 16, said step of applying said insert further comprising:
permanently applying said insert member to said recessed area on said base mat by applying an adhesive material between said insert member and said base mat.

18. The method of manufacturing a customizable elastomeric mat of claim 16, said first pattern further comprising raised rib structures on the top surface of said base mat and said second pattern further comprises raised rib structures on the top surface of said insert member.

19. The method of manufacturing a customizable elastomeric mat of claim 16, said indicia further comprising raised molded indicia on said top surface of said insert.
